(19) United States
(12) Patent Application Publication
(10) Pub. No.: US 2026/0217984 A1
(43) Pub. Date: Jul. 30, 2026

(54) POLYMER EMULSIONS FOR SOUND DAMPING APPLICATIONS

(71) Applicant: BASE SE, Ludwigshafen am Rhein (DE)

(72) Inventors: Akbar S. Hussaini, Charlotte, NC (US); Senthilkumar RENGASAMY, Charlotte, NC (US)

(21) Appl. No.: 19/146,957

(22) PCT Filed: Feb. 10, 2023
(86) PCT No.: PCT/US2023/012831

§ 371 Date: Jul. 10, 2025

Related U.S. Application Data
(60) Provisional application No. 63/438,322, filed on Jan. 11, 2023.

(51) Int. Cl. C09D 5/02; C09D 7/45; C09D 133/04; G10K 11/162

(52) U.S. Cl. CPC C09D 5/022; C09D 7/45; C09D 133/04; G10K 11/162

(57) ABSTRACT

The present disclosure provides a polymer emulsion comprising a first polymer with a first glass transition temperature (T_{g1}); a second polymer with a second glass transition temperature (T_{g2}); a third polymer with a third glass transition temperature (T_{g3}); and a fourth polymer with a fourth glass transition temperature (T_{g4}), wherein the first, second, third, and fourth polymers are not copolymerized. The polymer emulsion provides a sound damping loss factor of at least 0.1 over a temperature from 10° C. to 50° C. at 200 Hz.

### FIELD OF THE DISCLOSURE

The present disclosure is generally related to the field of polymers and in particular, for aqueous polymer emulsions, their methods of making and their uses in sound damping applications over a temperature range.

### BACKGROUND OF THE DISCLOSURE

To decrease the noise generated by vibrations in vehicles, appliances and machinery, damping materials are applied to the vibrating areas to effectively dissipate the vibrational energy. Applying mastic or asphaltic pads to the vibrating surfaces can dissipate some of the vibrational energy, but this process is labor intensive in the application and expensive as complicated shapes must be produced to cover the critical areas. Vibration damping coatings which are epoxy or PVC based are also used yet these are expensive and contain volatile organic compounds which can create a hazard when applying the coating. Neither of these damping technologies offer a cost effective and low VOC solution for effective damping for vehicles, appliances and machinery.

Formulations containing aqueous emulsions of acrylic polymers are known in the art to be effective in vibration damping. These formulations are water-based and do not contain any hazardous volatile organic chemicals. They are viscous materials which can be applied by various techniques, but are most often robotically sprayed onto the substrate which minimizes the labor of application and allows the material to be applied only in areas which need damping and in customized thicknesses to reach the desired level of vibrational damping.

However, these emulsions often only provide effective damping within a narrow temperature range. There is a need in the industry to improve upon aqueous emulsions for better damping performance and better formulation properties.

### SUMMARY

The following are embodiments of the invention:

A first embodiment, is a polymer emulsion comprising: a first polymer with a first glass transition temperature (T_{g1}); a second polymer with a second glass transition temperature (T_{g2}); a third polymer with a third glass transition temperature (T_{g3}); and a fourth polymer with a fourth glass transition temperature (T_{g4}), wherein the first, second, third, and fourth polymers are not copolymerized, the weight ratio of the first polymer to the second polymer to the third polymer to the fourth polymer is W:X:Y:Z, and W, X, Y, and Z independently may be from 0.5 to 2, and the polymer emulsion provides a sound damping loss factor of at least 0.1 over a temperature from 10° C. to 50° C. at 200 Hz.

A second embodiment is the polymer emulsion of the first embodiment, wherein each of T_{g1}, T_{g2}, T_{g3} and T_{g4} are from −60° C. to 60° C.

A third embodiment is the polymer emulsion of either the first embodiment or the second embodiment, wherein T_{g1} is from −15° C. to 20° C., T_{g2} is from −30° C. to 30° C., T_{g3} is from −40° C. to 10° C., and T_{g4} is from −30° C. to 10° C.

A fourth embodiment is the polymer emulsion of any one of the first through third embodiments, wherein the weight ratio of the first polymer to the second polymer to the third polymer to the fourth polymer is W:X:Y:Z, and W, X, Y, and Z independently may be from 0.75 to 1.25.

A fifth embodiment is the polymer emulsion of any one of the first through fourth embodiments, wherein the polymer emulsion has an overall glass transition temperature (T_{ge}) from −15° C. to 30° C.

A sixth embodiment is the polymer emulsion of any one of the first through fifth embodiments, wherein each of the first, second, third, and fourth polymer independently comprise a polymer selected from the group consisting of: polyacrylate, polyurethane, polystyrene, polystyrene-butadiene, polyamide, polyester, and polyvinyl chloride.

A seventh embodiment is a substrate coated with the polymer emulsion of any one of the first through sixth embodiments.

An eighth embodiment is a method of producing a polymer emulsion comprising: combining a first polymer, a second polymer, a third polymer, and a fourth polymer in a weight ratio of W:X:Y:Z respectively, wherein W, X, Y, and Z are independently from 0.5 to 2, forming a mixture of polymers; adding an emulsion agent to the mixture of polymers; and mixing the emulsion agent and mixture of polymers to form the polymer emulsion wherein the polymer emulsion provides a sound damping loss factor of at least 0.1 over a temperature from 10° C. to 50° C. at 200 Hz.

A ninth embodiment is the method of the ninth embodiment, wherein W, X, Y, and Z are independently from 0.75 to 1.25.

A tenth embodiment is the method of either the eighth embodiment or the ninth embodiment, wherein the polymer emulsion has an overall glass transition temperature from −15° C. to 30° C.

An eleventh embodiment is the method of any one of the eighth through tenth embodiments, wherein the first polymer has a first glass transition temperature from −15° C. to 20° C., the second polymer has a second glass transition temperature from −30° C. to 30° C., the third polymer has a third glass transition temperature from −40° C. to 10° C., and the fourth polymer has a fourth glass transition temperature from −30° C. to 10° C.

A twelfth embodiment is the method of any one of the eight through eleventh embodiments, wherein the emulsion agent is added in an amount from 0.1 to 2.0 wt % based on the total weight of the polymer emulsion.

A thirteenth embodiment is the method of any one of the eighth through twelfth embodiments, wherein each of the first, second, third, and fourth polymer independently comprise a polymer selected from the group consisting of: polyacrylate, polyurethane, polystyrene, polystyrene-butadiene, polyamide, polyester, and polyvinyl chloride.

A fourteenth embodiment is the polymer emulsion of any one of the first through thirteenth embodiments, further comprising four or more polymers with different glass transition temperatures (T_{gx}).

A fifteenth embodiment is a polymer emulsion comprising: a first polymer with a first glass transition temperature (T_{g1}); a second polymer with a second glass transition temperature (T_{g2}); and a third polymer with a third glass transition temperature (T_{g3}); wherein the first, second, and third, polymers are not copolymerized, the weight ratio of the first polymer to the second polymer to the third polymer is X:Y:Z, and X, Y, and Z independently may be from 0.5 to 2, and the polymer emulsion provides a sound damping loss factor of at least 0.1 over a temperature from 10° C. to 50° C. at 200 Hz.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1A shows the set up to determine and compare vibration loss factors over a range of temperatures.

FIG. 1B shows CLF (Composite Loss Factor) of a resonant mode as determined from the frequency response function by the half-power-bandwidth method.

FIG. 2 is a graphical depiction of damping profiles for multiple damping emulsions in accordance with Example 2; and

FIG. 3 is a graphical depiction of a damping profile for a damping emulsion in accordance with Example 2.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

The present disclosure provides polymer emulsions for sound damping. In particular, the present disclosure provides aqueous polymer emulsions for sound damping over a broad range of temperatures. The emulsions may be used in liquid applied sound damping (LASD) formulations. The emulsions may comprise a blend or mixture of a plurality of emulsions. The emulsions may comprise a dual feed emulsion.

### I. Definitions

Unless otherwise specified, “a” and “and” means one or more.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, the term acrylate or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

As used herein, the term styrene refers to styrene or α-methylstyrene.

As used herein, the term “support resin” refers to a low molecular weight copolymer containing styrene, acrylic, and acidic monomers that can be dispersed in water upon neutralization of the acidic component. Illustrative examples of a support resin include a carboxylic acid-functional support resin. Another example of a support resin includes one that is about 50 wt % styrene, about 25 wt % acrylic acid, and about 25 wt % (meth)acrylate. In some embodiments, the support resin comprises about 27% styrene, 10% acrylic acid, 49% methyl methacrylate, and 14% butyl acrylate. In some embodiments, the support resin comprises about 26% styrene, 33% alpha-methyl styrene, 26% acrylic acid, and 16% carbitol acrylate.

### II. Sound Damping Emulsions

As described above, the present disclosure relates to emulsions for sound damping. More particularly, the present disclosure describes aqueous polymer emulsions in liquid applied sound damping (LASD) formulations to produce highly effective damping materials for use in vehicles, appliances and machinery to mitigate the adverse effects of unwanted vibrations. Also disclosed are a method to produce highly effective aqueous polymer emulsions which can be tuned to provide effective damping over a broad range of temperatures. The emulsions as described herein may also be referred to as “damping formulations” or “damping compositions”.

A typical formulation for a LASD material may comprise one or more of an aqueous polymer emulsion, an inorganic filler, an emulsifying agent and a viscosity modifier. The polymer from the emulsion provides the viscoelastic properties of the final dried product. The proper balance of viscous and elastic properties at the desired temperatures may provide for effective damping properties. The inorganic filler, which may be for example, one or more of calcium carbonate, barium sulfate, mica, may provide mass and stiffness to the dried LASD material. Good interaction between the polymer and the filler may improve the viscoelastic balance and enhance the damping characteristics. The emulsifying agent may be used to help disperse the inorganic fillers in the formulation and allow the highly filled formulation to remain fluid, while thickeners may be added to achieve the correct viscosity profile so the material is fluid enough to be pumped and sprayed yet thick enough so it will not sag and flow when applied. Other ingredients may also be added to harden or soften the product. Colorants may also be added. Defoamers may also be added to help in the elimination of trapped air bubbles and other additives may be included to improve the drying/baking characteristics.

The emulsions may be formed through an emulsion polymerization, which relies on the use of small molecule surfactants containing a polar/hydrophilic group and a nonpolar/hydrophobic group. The amphiphilic nature of these materials allows them to effectively stabilize heterogeneous solutions (i.e. polymer particles in water).

The present emulsions may utilize a resin support.

The emulsions may comprise one or more polymers. For example, an emulsion of the present disclosure may comprise two, three, four, or any suitable number of polymers. In embodiments where multiple polymers are used, each polymer may have different properties, such as glass transition temperatures (Tg). Multiple polymers with different Tg values may be combined to form a damping emulsion that provides a broad damping profile over a range of temperatures.

In embodiments where multiple polymers are used, the polymers may be present in any suitable ratio. For example, a damping formulation may comprise four polymers in a weight ratio of W:X:Y:Z. W, X, Y, and Z may each independently be 0.5, 0.6. 0.7, 0.75, 0.8, 0.9, 1, 1.1, 1.2, 1.25, 1.3, 1.4, 1.5, 1.6, 1.7, 1.75, 1.8, 1.9, 2, or any range including any of these values as endpoints. For example, W, X, Y, and Z may each independently be from 0.5 to 2, from 0.5 to 1.5, from 0.75 to 1.5, from 0.75 to 1.25, from 0.75 to 1.2, from 0.9 to 1.1, or any subrange within these ranges. The weight ratios of the polymers may be altered to tune the damping profile of the damping formulation.

The emulsions may comprise a low molecular weight copolymer. For example, the polymers within the emulsion may have a number average molecular weight from about 1,000 g/mol to about 75,000 g/mol. This may include a number average molecular weight from about 1,000 g/mol to about 65,000 g/mol or from about 1,000 g/mol to about 50,000 g/mol or from about 1,000 g/mol to about 30,000 g/mol or from about 1,000 g/mol to about 20,000 g/mol, or from about 1,000 g/mol to about 15,000 g/mol, or from about 1,000 g/mol to about 10,000 g/mol. In some embodiments, the low molecular weight copolymer may have a weight average molecular weight from about 1,500 g/mol to about 35,000 g/mol. This includes a weight average molecular weight from about 4,000 g/mol to about 25,000 g/mol.

In some embodiments, the low molecular weight copolymer may be a copolymer of acrylic acid and styrene.

Suitable monomers employed in the preparation of the emulsion include, but are not limited to, acrylic acid, methacrylic acid, styrene, alpha-methylstyrene, hydroxyethylmethacrylate and esters of acrylic acid and methacrylic acid.

In some embodiments, the low molecular weight copolymer may be a carboxylic acid-functional resin. In some embodiments, the carboxylic acid-functional resin may be an alkali soluble resin. In other words, the carboxylic acid-functional resin may react with alkali materials to form ion salts at the carboxylate groups of the polymer, thereby enhancing the water solubility characteristics of the resin. Suitable monomers for preparation of the carboxylic acid-functional resin and the low molecular weight copolymer include monomers such as acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, styrene, methyl styrene, alpha-methyl styrene, ethyl styrene, isopropyl styrene, tertiary-butyl styrene, ethyl methacrylate, methyl methacrylate, butyl acrylate, butyl methacrylate, 2-ethylhexyl acrylate, ethyl acrylate, vinyl acetate, methyl acrylate, open-chain conjugated dienes, 2-hydroxyethyl methacrylate, 2-hydroxyethyl acrylate, methylol acrylamide, glycidyl acrylate, glycidyl methacrylate, vinyl esters, vinyl chloride, or mixtures of any two or more such monomers. In some embodiments, the carboxylic acid-functional support resin includes polymerized monomers of one or more of ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, glycidyl acrylate, glycidyl methacrylate, or mixtures of any two or more such monomers. In one embodiment, the carboxylic acid-functional resin includes polymerized monomers of one or more acrylic acid, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, glycidyl acrylate, glycidyl methacrylate, styrene, methyl styrene, alpha-methyl styrene, diacetone acrylamide, ureido methacrylate, or a mixture of any two or more such monomers. In some embodiments, the carboxylic acid-functional resin may include a copolymer including two or more of styrene, methyl methacrylate, and acrylic acid. In some embodiments, the carboxylic acid-functional support resin may include a copolymer of acrylic acid and styrene.

The polymer or polymers used within the emulsions may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints.

The emulsion or combination of polymers may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints.

The polymers may be formed from emulsion-polymerizable monomers. Emulsion-polymerizable monomers are known in the art, see e.g. U.S. Pat. Nos. 4,820,762; 7,253,218; 7,893,149; and U.S. Patent Publication No. 2015/0166803. The emulsion polymerizable monomer may include an ethylenically unsaturated monomer. In some embodiments, emulsion polymerizable monomer may include at least one ethylenically unsaturated nonionic monomer. By “nonionic monomer” herein is meant that the copolymerized monomer residue does not bear an ionic charge between pH 1 and 14. Suitable ethylenically unsaturated nonionic monomers include, but are not limited to, (meth)acrylic ester monomers including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate; (meth)acrylonitrile; (meth)acrylamide; ureido-functional monomers; monomers bearing acetoacetate-functional groups; styrene and substituted styrenes; butadiene; ethylene, propylene, .alpha.-olefins such as 1-decene; vinyl acetate, vinyl butyrate and other vinyl esters; and vinyl monomers such as vinyl chloride, vinylidene chloride.

The emulsion-polymerizable monomer may include acrylate monomers, methacrylate monomers, styrene monomers, or a mixture of any two or more thereof. In some embodiments, the emulsion polymerizable monomer does not include styrene monomers.

In some embodiments, the at least one emulsion polymerizable monomer may be a C₁-C₄ acrylate, a C₁-C₄ (meth)acrylate, or a mixture of any two or more thereof. In some embodiments, the emulsion-polymerizable monomer may be n-butyl acrylate, 2-ethylhexyl acrylate, methyl acrylate, methyl methacrylate, styrene, ethyl acrylate, or a mixture of any two or more thereof.

In some embodiments, the emulsion polymerizable polymer may include one or more keto-functional monomers. Examples of keto-functional monomers include diacetone acrylamide, diacetone methacrylamide, diacetone acrylate, diacetone methacrylate, acetoacetoxymethyl (meth)acrylate, 2-(acetoacetoxy)ethyl (meth)acrylate, 2-acetoacetoxypropyl (meth)acrylate, butanediol-1,4-acrylate-acetylacetate, vinyl methyl ketone, vinyl ethyl ketone, and vinyl isobutyl ketone, allyl acetoacetate, vinyl acetoacetate, or vinyl acetoacetamide. In one embodiment, the emulsion polymerizable polymer includes a repeat unit derived from diacetone acrylamide.

The emulsions may be formed thorough an emulsion polymerization reaction, which may involve at least one emulsion polymerizable monomer, a low molecular weight copolymer, and other ingredients and/or reagents, such as an initiator.

The initiator may may be a water-soluble compound for ready mixing and blending with the emulsions. Non-limiting examples of water-soluble initiators for the emulsion polymerization include ammonium salts and alkali metal salts of peroxydisulfuric acid, e.g., sodium peroxodisulfate, hydrogen peroxide or organic peroxides, e.g., tert-butyl hydroperoxide. The initiator may be a thermal initiator. Suitable initiators include, but are not limited to 2,2′-azobis(2-methylpropionamidine) dihydrochloride, ammonium persulfate, sodium persulfate, and potassium persulfate. Also suitable are reduction-oxidation (redox) initiator systems. The redox initiator systems consist of at least one, usually inorganic, reducing agent and an organic or inorganic oxidizing agent. The oxidizing component comprises, for example, the emulsion polymerization initiators already identified above. The reducing components comprise, for example, alkali metal salts of sulfurous acid, such as, for example sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used along with soluble metal compounds whose metallic component is able to exist in a plurality of valence states. Typical redox initiator systems are, for example, ascorbic acid/iron (II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid and sodium disulfite. The stated compounds are used usually in the form of aqueous solutions, with the lower concentration being determined by the amount of water that is acceptable in the dispersion, and the upper concentration by the solubility of the respective compound in water. Generally speaking, the concentration is 0.1% to 30% by weight, preferably 0.5% to 20% by weight, more preferably 1.0% to 10% by weight, based on the solution. The amount of the initiators is generally 0.1% to 10% by weight, preferably 0.5% to 5% by weight, based on the monomers to be polymerized. It is also possible for two or more different initiators to be used in the emulsion polymerization.

In some embodiments, an initiator may be ammonium persulfate and an oxidizer may be t-butyl hydroperoxide. In such case, a weight ratio between ammonium persulfate and t-butyl hydroperoxide may range from 40:1 to 2:1 or from 30:1 to 4:1 or any subrange or value within these ranges.

In some embodiments, the damping formulation may include at least one of a filler, a defoaming agent, a rheological modifier, an emulsifying agent (i.e. “dispersing agent” or “dispersant”), a coalescent agent, a pigment, or a biocide.

In some embodiments, the damping formulation may include one or more filler, which may constitute from about 40 wt % to about 90 wt % or from 45 wt % to 85 wt % or from 50 wt % to 80 wt % or any value or subrange within these ranges of the formulations. Examples of fillers may include, but are not limited to, calcium carbonate, barium sulfate, glass filler, magnesium carbonate, plastic microsphere, mica, powdered slate, montmorillonite flakes, glass flakes, metal flakes, graphite, graphene, talc, iron oxide, clay minerals, cellulose fibers, mineral fibers, carbon fibers, glass or polymeric fibers or beads, ferrite, calcium carbonate, calcium magnesium carbonate, calcium silicate, barytes, ground natural or synthetic rubber, silica, aluminum hydroxide, alumina and mixtures thereof. In some embodiments, the damping formulation may include a mixture of any two or more such fillers.

In some embodiments, the damping formulation may include a defoaming agent (a defoamer). Examples of defoaming agents include Foamaster® S (produced by BASF), Rhodoline® DF 540 (produced by Rhodia), Rhodoline® 635 (produced by Solvay), Foamaster® MO 2170 (produced by BASF), or Foamaster® MO 2190 (produced by BASF). The damping formulation may include as much of a defoaming agent as needed to provide the desired foaming characteristics. In some embodiments, the defoaming agent may constitute less than 1 wt % of the damping formulation. In some embodiments, the damping formulation more than 0 wt % up to about 1 wt % of the defoaming agent.

In some embodiments, the damping formulation may include a thickener or a rheological modifier. Examples of rheological modifiers include Rheovis® HS 1152; Rheovis® HD 1152 (produced by BASF) or Rheovis® AS 1130 (produced by BASF). The damping formulation may include as much of a rheological modifier as needed to provide the desired solution characteristics. In some embodiments, the formulation may include less than 1 wt % of the rheological modifier. In other embodiments, the formulation may include more than 0 wt % up to about 1 wt % of the rheological modifier.

In some embodiments, the damping formulation includes a dispersant. One non-limiting example of a dispersant is Dispex® CX 4320 (produced by BASF). The damping formulation may include as much dispersant as need to provide the desired characteristics for the formulation. In some embodiments, the formulation may include from 0.1 to 2.0 wt % or from 0.25 to 1.5 wt % or from 0.5 to 1.0 wt % or any value or subrange within these ranges.

In some embodiments, the damping formulation may include a biocide. Suitable non-limiting examples of a biocide include Acticide® MBS (a mixture of 1,2-benzisothiazolin-3-one (2.5%) and 2-methyl-4-isothiazolin-3-one (2.5%)), Acticide® MV-14 (a mixture of 5-chloro-2-methyl-2H-isothiazol-3-one and 2-methyl-2H-isothiazol-3-one in a ratio of 3:1 respectively), and Acticide® CEM 2 (a mixture of 1,2-benzisothiazol-3 (2H)-one (9.3-10.7%), 2-methylisothiazol-3 (2H)-one (4.7-5.2%), and 5-chloro-2-methyl-2H-isothiazol-3-one (0.9-1.1%).

### III. Methods of Making and Applying Emulsions

The formulations as described herein may be prepared through emulsion polymerization as described above. Additional additives may be added through mixing or any other combination method.

In some embodiments, the damping formulation may be deposited on a surface of the source of mechanical vibrations in a form of a layer. Such a layer may have a thickness ranging from 0.5 mm to 12 mm or from 0.5 mm to 10 mm or from 1.0 mm to 10 mm or from 1.5 mm to 8 mm or from 2 mm to 6 mm or any value or subrange within these ranges.

The damping formulation may be deposited in a continuous or a non-continuous layer, and may be applied in any suitable pattern or geometry. Details regarding application patterns may be found in U.S. provisional applications 63/067,671 and 63/067,646, both filed on Aug. 19, 2020, the disclosures of which are incorporated herein in their entirety.

The damping formulation may be deposited on a source of mechanical vibrations by a number of ways. For example, in some embodiments, the damping formulation may be sprayed on a source of mechanical vibrations. Yet in some embodiments, the damping formulation may be painted on a source of mechanical vibrations.

A source of mechanical vibration may be a body, which is capable of producing or transmitting vibrations. The LASD formulations disclosed herein can be applied to a variety of bodies capable of producing or transmitting vibrations. Non-limiting examples of such bodies include an auto interior cabin; pickup truck interior cabin and underside of truck bed; interior panels of trucks; walls, ceilings, and floors of rail cars; aerospace vehicles or devices; elevators; washing machines; clothes driers; automatic dishwashers; and the underside of sinks.

The damping formulations provided herein may also be applied to a variety of materials, including, for example, metal, steel, aluminum, plastic, wood, wallboard, or gypsum board.

### IV. Properties of Emulsions

When applied to a substrate, the damping formulations may provide sound damping over a broad range of temperatures at any suitable frequency (e.g. 100 Hz, 200 Hz, 300 Hz, 400 Hz, 500 Hz, etc.). The damping formulations may provide a composite loss factor of at least 0.1 at 200 Hz over a temperature range of at least 20° C., at least 25° C., at least 30° C., at least 35° C., at least 40° C., at least 45° C., at least 50° C., at least 55° C., at least 60° C., or any range including any two of these values as endpoints. For example, the formulations may provide a loss factor of at least 0.1 at 200 Hz over a temperature range from 20° C. to 60° C., from 30° C. to 60° C., from 40° C. to 60° C., or any subrange within these ranges.

Stated differently, the formulations herein may provide a composite loss factor of at least 0.1 at 200 Hz at a temperature from 0° C. to 60° C., from 0° C. to 50° C., from 10° C. to 60° C., from 20° C. to 60° C., from 10° C. to 50° C., from 20° C. to 50° C., from 20° C. to 60° C., from 30° C. to 60° C., or any subrange within any of these ranges.

The present formulations may have a wide Tg range. For example, the formulations herein may have a Tg from 0° C. to 60° C., from 0° C. to 50° C., from 10° C. to 60° C., from 20° C. to 60° C., from 10° C. to 50° C., from 20° C. to 50° C., from 20° C. to 60° C., from 30° C. to 60° C., or any subrange within any of these ranges.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXAMPLES

### Test Methods

The following testing, measurement, and calculation methods were used in the foregoing examples.

### GPC

GPC spectra were acquired with a Waters 2695 instrument and was used to determine molecular weight of polymers using THE as the mobile phase at 40° C. and a RI detector. All samples were analyzed for Mₙ, M_{w}, and PDI using elution times calibrated against polystyrene molecular weight standards.

### Solids Content

Solids content of the dispersions were measured gravimetrically by drying about a 500 mg sample of dispersions in a 140° C. oven for 1 hour.

### Particle Size

Particle size of the dispersions were measured using a nano-flex particle sizer from Microtrac.

### Minimum Film Formation Temperature (MFFT)

The MFFT was measured according to ASTM D2354-10.

### Glass Transition Temperature (Tg)

Tg was measured according to ASTM D3418-15.

### Viscosity

Viscosity was measured according to ASTM D2196-18.

### Molecular Weights

The number average molecular weight (Mₙ) is the statistical average molecular weight of all the polymer chains in the polymer and is defined by

$${M}_{n} = ( {Σ N}_{i} {M}_{i} ) / {ΣN}_{i}$$

where Mᵢ is the molecular weight of a chain and Nᵢ is the number of chains of that molecular weight.

The weight average molecular weight (M_{w}) is defined by:

$${M}_{w} = ( {Σ Ni Mi}^{2} ) / ΣNi$$

Compared to Mn, Mw takes into account the molecular weight of a chain in determining contributions to the molecular weight average. The more massive the chain, the more the chain contributes to Mw.

Higher average molecular weights (M_{z}) can be defined by the equation:

$${M}_{z} = ( {Σ Ni Mi}^{3} ) / ΣNi$$

The dispersity index or polydispersity index (PDI) is a measure of the distribution of molecular mass in a given polymer sample. PDI of a polymer is calculated:

$$PDI = {M}_{w} / {M}_{n}$$

where the weight average molecular weight and the statistical average molecular weight are defined above.

The target composite loss factor (CLF) of the instant invention is a CLF equal to 0.1 or greater over the temperature range 0° C. to 60° C. measured at 200 Hertz.

### Damping Quantification

Under dynamic mechanical loading several viscoelastic materials (i.e. polymers) have the ability to effectively dissipate mechanical energy as heat. This phenomenon, known as viscous damping, is a complex response sensitive to both temperature and vibration frequency. It occurs because, over a broad range of temperature and strain rates, viscoelastic materials follow neither Hooke's law of perfectly elastic solids (i.e. stress is proportional to strain and independent of strain rate) nor Newton's law of perfectly viscous liquids (i.e. stress is proportional to strain rate and independent of strain). Instead, these materials exhibit both elastic (energy storage) and viscous (energy loss) behavior. The duality of this material is best described by the complex modulus (E*) equation where the E′ and E″ are the storage and loss moduli, respectively:

$${E}^{*} = {E}^{′} + {iE}^{″} \qquad ( Equation 1 )$$

This equation can also be written as follows.

$${E}^{*} = {E}^{′} ( 1 + i η ) \qquad ( Equation 2 )$$

In Equation 2, η=tan δ=E″/E′.

In order to quantify damping in a LASD formulation the Oberst test is often employed. To perform this analysis a thin steel bar is first coated with a desired thickness of LASD formulation. The dimensions of the bar can vary depending on customer specifications. The bar is then placed in an oven to remove water. One end of the bar is then sandwiched between two root blocks to prevent any vibrations from occurring in the clamped section of the bar. The bar is clamped in a fixture and enclosed in a climate chamber. Vibrational displacement is measured using a piezoelectric or motion transducer. A computer driven magnetic exciter applies a range of vibrational frequencies to the bar over a set temperature range. At each temperature the reduction in vibration is measured and compared to an uncoated steel bar. The vibrational reduction is termed the composite loss factor (CLF) and is plotted versus temperature.

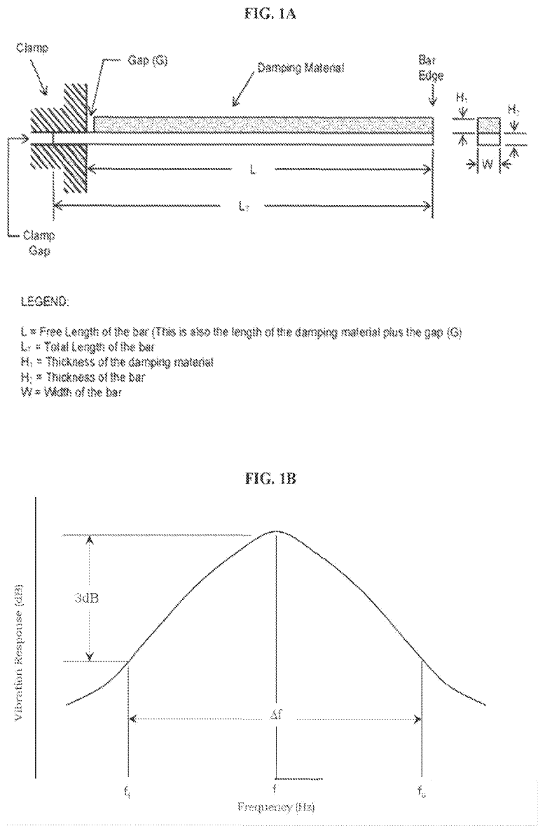

As shown in FIG. 1A, steel bars (Oberst bars) were tested to determine and compare vibration loss factors over a range of temperatures. Each bar was clamped into a heavy base. A non-contacting transducer excited the free-end of the bar and another non-contacting transducer near the fixed-end of the bar sent output to a processing unit to calculate the CLF. From the excitement measurements, mobility (frequency response function (“FRF”)) data was acquired relative to the force input in 1 Hz bands. Following the ASTM E756 guidelines, the CLF of a resonant mode was determined from the frequency response function by the half-power-bandwidth method (FIG. 1B) using the following equation:

$$C L F = A ( \frac{{E}_{2}}{{E}_{1}} ) {( \frac{{H}_{2}}{{H}_{1}} )}^{2} {η}_{2} = \frac{Δ f}{f}$$

where CLF is the composite loss factor, E is the Young's modulus, H is the thickness, Δf is peak width, f is peak height, and A is a constant.

### Example 1: Formulation Preparation

In this example, five damping formulations to be tested were prepared, as further defined below. A list of the materials used and their functions are listed in Table 1 below.

TABLE 1
Damping Formulation Materials

| Material | Function |
|---|---|
| Emulsion Polymers | Binder |
| WATER | Diluent |
| Dispex CX 4230 | Filler Dispersant |
| Foamaster MO 2190 | Defoamer |
| Kathlon LX 1.5% | Biocide |
| Dipropylene Glycol | Anti-freeze, plasticizer |
| Aurasperse W7017 | Carbon Black |
| Pluronic F87 | Non-ionic thermal gelation |
| Pendford Gum 280 | Starch, metal adhesion |
| Dualite U010-130 W | Microspheres |
| Bentone CT | Clay thickener |
| SUZORITE MICA 200-HK | Mica |
| GPR200 saks | Calcium Carbonate |
| Rheovis AS 1130 | Thickener |

The formulations to be tested were prepared using the components shown below in Tables 2-6, wherein Polymer 1 is an acrylic dispersion polymer with Tg of 4° C.; Polymer 2 is an aqueous dispersion of an acrylic ester copolymer with Tg of 50° C.; Polymer 3 is an aqueous dispersion of an acrylic ester copolymer with Tg of 18° C.; and Polymer 4 is an aqueous dispersion of an acrylic ester copolymer with Tg of −12° C.

Formulation 1 included a mixture of all four polymers, while Formulations 2-5 included only Polymer 1, Polymer 2, Polymer 3 or Polymer 4, respectively. Each component was added to the mixing vessel separately while mixing the contents with a mechanical stirrer. Following the complete addition of all components, the formulation was stirred for an additional 30 minutes.

TABLE 2
Damping components, amounts, and
solid percentage, Formulation 1

| | Batch Size | |
|---|---|---|
| Components | (g) | Solids (%) |
| Polymer 1 | 11.2343 | 54.80% |
| Polymer 2 | 11.2282 | 54.83% |
| Polymer 3 | 11.7556 | 52.37% |
| Polymer 4 | 11.1793 | 55.07% |
| DI-Water | 1.6251 | 0.00% |
| Dispex CX 4230 | 0.4896 | 28.00% |
| Foamaster MO 2190 (WBA) | 0.1530 | 100.00% |
| Dipropylene Glycol | 1.0404 | 100.00% |
| Aurasperse W7017 (Black) | 0.2040 | 100.00% |
| Pluronic F87 (30% Solution) | 0.6120 | 30.00% |
| Penford Gum 280 | 2.2847 | 100.00% |
| Dualite U018-130W | 0.7242 | 100.00% |
| Bentone CT | 1.1424 | 100.00% |
| Mica | 13.5453 | 100.00% |
| Calcium Carbonate | 32.2720 | 100.00% |
| Rheovis AS 1130 | 0.5100 | 20.00% |
| Total | 100.00 | |

TABLE 3
Damping components, amounts, and
solid percentage, Formulation 2

| | Batch Size | |
|---|---|---|
| Components | (g) | Solids (%) |
| Polymer 1 | 44.9374 | 54.80% |
| Polymer 2 | 0.0000 | 54.83% |
| Polymer 3 | 0.0000 | 52.37% |
| Polymer 4 | 0.0000 | 55.07% |
| DI-Water | 2.0800 | 0.00% |
| Dispex CX 4230 | 0.4896 | 28.00% |
| Foamaster MO 2190 (WBA) | 0.1530 | 100.00% |
| Dipropylene Glycol | 1.0404 | 100.00% |
| Aurasperse W7017 (Black) | 0.2040 | 100.00% |
| Pluronic F87 (30% Solution) | 0.6120 | 30.00% |
| Penford Gum 280 | 2.2847 | 100.00% |
| Dualite U018-130W | 0.7242 | 100.00% |
| Bentone CT | 1.1424 | 100.00% |
| Mica | 13.5453 | 100.00% |
| Calcium Carbonate | 32.2720 | 100.00% |
| Rheovis AS 1130 | 0.5100 | 20.00% |
| Total | 100.00 | |

TABLE 4
Damping components, amounts, and
solid percentage, Formulation 3

| | Batch Size | |
|---|---|---|
| Components | (g) | Solids (%) |
| Polymer 1 | 0.0000 | 54.80% |
| Polymer 2 | 44.9128 | 54.83% |
| Polymer 3 | 0.0000 | 52.37% |
| Polymer 4 | 0.0000 | 55.07% |
| DI-Water | 2.1096 | 0.00% |
| Dispex CX 4230 | 0.4896 | 28.00% |
| Foamaster MO 2190 (WBA) | 0.1530 | 100.00% |
| Dipropylene Glycol | 1.0404 | 100.00% |
| Aurasperse W7017 (Black) | 0.2040 | 100.00% |
| Pluronic F87 (30% Solution) | 0.6120 | 30.00% |
| Penford Gum 280 | 2.2847 | 100.00% |
| Dualite U018-130W | 0.7242 | 100.00% |
| Bentone CT | 1.1424 | 100.00% |
| Mica | 13.5453 | 100.00% |
| Calcium Carbonate | 32.2720 | 100.00% |
| Rheovis AS 1130 | 0.5100 | 20.00% |
| Total | 100.00 | |

TABLE 5
Damping components, amounts, and
solid percentage, Formulation 4

| | Batch Size | |
|---|---|---|
| Components | (g) | Solids (%) |
| Polymer 1 | 0.0000 | 54.80% |
| Polymer 2 | 0.0000 | 54.83% |
| Polymer 3 | 47.0225 | 52.37% |
| Polymer 4 | 0.0000 | 55.07% |
| DI-Water | 0.0000 | 0.00% |
| Dispex CX 4230 | 0.4896 | 28.00% |
| Foamaster MO 2190 (WBA) | 0.1530 | 100.00% |
| Dipropylene Glycol | 1.0404 | 100.00% |
| Aurasperse W7017 (Black) | 0.2040 | 100.00% |
| Pluronic F87 (30% Solution) | 0.6120 | 30.00% |
| Penford Gum 280 | 2.2847 | 100.00% |
| Dualite U018-130W | 0.7242 | 100.00% |
| Bentone CT | 1.1424 | 100.00% |
| Mica | 13.5453 | 100.00% |
| Calcium Carbonate | 32.2720 | 100.00% |
| Rheovis AS 1130 | 0.5100 | 20.00% |
| Total | 100.00 | |

TABLE 6
Damping components, amounts, and
solid percentage, Formulation 5

| | Batch Size | |
|---|---|---|
| Components | (g) | Solids (%) |
| Polymer 1 | 0.0000 | 54.80% |
| Polymer 2 | 0.0000 | 54.83% |
| Polymer 3 | 0.0000 | 52.37% |
| Polymer 4 | 44.7170 | 55.07% |
| DI-Water | 2.3054 | 0.00% |
| Dispex CX 4230 | 0.4896 | 28.00% |
| Foamaster MO 2190 (WBA) | 0.1530 | 100.00% |
| Dipropylene Glycol | 1.0404 | 100.00% |
| Aurasperse W7017 (Black) | 0.2040 | 100.00% |
| Pluronic F87 (30% Solution) | 0.6120 | 30.00% |
| Penford Gum 280 | 2.2847 | 100.00% |
| Dualite U018-130W | 0.7242 | 100.00% |
| Bentone CT | 1.1424 | 100.00% |
| Mica | 13.5453 | 100.00% |
| Calcium Carbonate | 32.2720 | 100.00% |
| Rheovis AS 1130 | 0.5100 | 20.00% |
| Total | 100.00 | |

### Example 2: Damping Testing

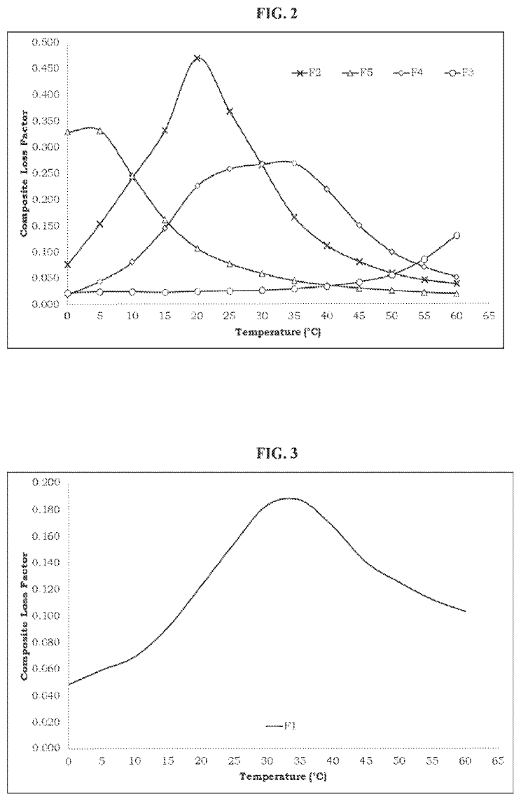

In this Example, each of the formulations made in Example 1 were tested for damping properties using the damping quantification test method described above. FIG. 2 shows the results for Formulations 2-5. FIG. 3 shows the results for Formulation 1. Each of the formulations are compared to a simulated target damping profile which shows an example of a profile with a composite loss factor of 0.1 or greater over a temperature range of 60° C. (from 0° C. to 60° C.). Table 7 shows the values for each formulation.

TABLE 7
Composite loss factor versus temperature

| | | Formu- | Formu- | Formu- | Formu- | Formu- |
|---|---|---|---|---|---|---|
| Temp. | Target | lation 1 | lation 2 | lation 3 | lation 4 | lation 5 |
| 0 | 0.1 | 0.043 | 0.076 | 0.022 | 0.018 | 0.329 |
| 5 | 0.11 | 0.059 | 0.154 | 0.024 | 0.044 | 0.332 |
| 10 | 0.12 | 0.069 | 0.242 | 0.024 | 0.081 | 0.246 |
| 15 | 0.15 | 0.091 | 0.332 | 0.023 | 0.146 | 0.162 |
| 20 | 0.18 | 0.122 | 0.471 | 0.025 | 0.227 | 0.107 |
| 25 | 0.19 | 0.154 | 0.369 | 0.026 | 0.259 | 0.078 |
| 30 | 0.2 | 0.183 | 0.266 | 0.027 | 0.268 | 0.059 |
| 35 | 0.19 | 0.187 | 0.167 | 0.030 | 0.270 | 0.045 |
| 40 | 0.18 | 0.167 | 0.113 | 0.035 | 0.221 | 0.037 |
| 45 | 0.15 | 0.140 | 0.082 | 0.043 | 0.151 | 0.031 |
| 50 | 0.12 | 0.125 | 0.060 | 0.057 | 0.101 | 0.027 |
| 55 | 0.11 | 0.112 | 0.047 | 0.087 | 0.072 | 0.023 |
| 60 | 0.1 | 0.103 | 0.040 | 0.133 | 0.053 | 0.021 |

As shown, the damping profiles for the formulations comprising multiple polymers are relatively broad and have a loss factor of at least 0.1 over a wide temperature range.

1.-13. (canceled)

14. A polymer emulsion comprising:
a first polymer with a first glass transition temperature (T_{g1});
a second polymer with a second glass transition temperature (T_{g2});
a third polymer with a third glass transition temperature (T_{g3}); and
a fourth polymer with a fourth glass transition temperature (T_{g4}), wherein the first, second, third, and fourth polymers are not copolymerized, the weight ratio of the first polymer to the second polymer to the third polymer to the fourth polymer is W:X:Y:Z, and W, X, Y, and Z independently may be from 0.5 to 2, and the polymer emulsion provides a sound damping loss factor of at least 0.1 over a temperature from 10° C. to 50° C. at 200 Hz.

15. The polymer emulsion of claim 14, wherein each of T_{g1}, T_{g2}, T_{g3}, and T_{g4} are from −60° C. to 60° C.

16. The polymer emulsion of claim 15, wherein T_{g1} is from −15° C. to 20° C., T_{g2} is from −30° C. to 30° C., T_{g3} is from −40° C. to 10° C., and T_{g4} is from −30° C. to 10° C.

17. The polymer emulsion of claim 14, wherein the weight ratio of the first polymer to the second polymer to the third polymer to the fourth polymer is W:X:Y:Z, and W, X, Y, and Z independently may be from 0.75 to 1.25.

18. The polymer emulsion of claim 14, wherein the polymer emulsion has an overall glass transition temperature (T_{ge}) from −15° C. to 30° C.

19. The polymer emulsion of claim 14, wherein each of the first, second, third, and fourth polymer independently comprise a polymer selected from the group consisting of: polyacrylate, polyurethane, polystyrene, polystyrene-butadiene, polyamide, polyester, and polyvinyl chloride.

20. A substrate coated with the polymer emulsion of claim 14.

21. A method of producing a polymer emulsion comprising:
combining a first polymer, a second polymer, a third polymer, and a fourth polymer in a weight ratio of W:X:Y:Z respectively, wherein W, X, Y, and Z are independently from 0.5 to 2, forming a mixture of polymers;
adding an emulsion agent to the mixture of polymers; and
mixing the emulsion agent and mixture of polymers to form the polymer emulsion, wherein the polymer emulsion provides a sound damping loss factor of at least 0.1 over a temperature from 10° C. to 50° C. at 200 Hz.

22. The method of claim 21, wherein W, X, Y, and Z are independently from 0.75 to 1.25.

23. The method of claim 21, wherein the polymer emulsion has an overall glass transition temperature from −15° C. to 30° C.

24. The method of claim 21, wherein the first polymer has a first glass transition temperature from −15° C. to 20° C., the second polymer has a second glass transition temperature from −30° C. to 30° C., the third polymer has a third glass transition temperature from −40° C. to 10° C., and the fourth polymer has a fourth glass transition temperature from.

25. The method of claim 21, wherein the emulsion agent is added in an amount from 0.1 to 2.0 wt % based on the total weight of the polymer emulsion.

26. The method of claim 21, wherein each of the first, second, third, and fourth polymer independently comprise a polymer selected from the group consisting of: polyacrylate, polyurethane, polystyrene, polystyrene-butadiene, polyamide, polyester, and polyvinyl chloride.
